(19) United States
(12) Patent Application Publication
(10) Pub. No.: US 2004/0200335 A1
(43) Pub. Date: Oct. 14, 2004

(54) Musical invention apparatus

(76) Inventor: Maxwell John Phillips, Buderim (AU)

Correspondence Address: Maxwell Phillips, 271 Lindsay Road, Buderim, Queensland, 4556, AU

(21) Appl. No.: 10/490,699

(22) PCT Filed: Jun. 20, 2002
(86) PCT No.: PCT/AU02/00805

(30) Foreign Application Priority Data
Nov. 13, 2001 (AU) PR 8816

(51) Int. Cl. G09B 15/02

(52) U.S. Cl. 84/483.2

(57) ABSTRACT

A computer assisted apparatus and a method are provided that represents and describes a musical work in a graphical way, and using outboard devices or the computer keys and mouse, permits experimentation with musical ideas. Musical devices such as fills, suspensions, bends, overall structure, chord sequences, phrases, degrees of consonance and dissonance and melodic motifs and other musical constructions are visualised. In this way, manipulation and experimentation is accessible and an ordered method is provided to musical invention. Operators can build their own library of ideas as well as manipulate and experiment with ideas gathered from other sources. Playback would employ a musical synthesiser. These ideas so attained, when given life through the operator's personal musical style and voice, become integrated with the mental processes in the usual method of acquired musical language. Empowering the functionality of this invention is a unique view of music theory.

The invention is described as follows:

### TECHNICAL FIELD

This invention relates to music, in particular but not limited to, a computer assisted apparatus for facilitating musical invention as well as a method or process of musical invention.

### BACKGROUND ART

The currently available apparatus for musical composition is devised to provide a platform for a composer to assemble his or her ideas. Rhythm and harmony patterns are drawn from encoded patterns or the composer can write new patterns. Further instrumentation and vocals are then added in layers to build a musical work. These prior art methods and apparatus commonly exist both incorporated in electronic keyboards or as personal computer software programs where an outboard electronic keyboard is played into the computer through transfer of digital information. The structural elements in the finished musical works composed by these prior art methods and apparatus could be viewed as of two types as described below.

The first involves melody/harmony elements. While any musical work is fluid, the elements referred to here would be the arbitrary dissection of music that is used for analysis. Examples of such elements might be bars, fills, suspensions, bends, trills, melody/chord movements, overall structure, chord sequences, phrases and so on.

The second involves instrumentation and vocals. These are the separate voices that combine to sound the whole, audible work.

The main disadvantage of the prior art is that it does not directly aid in the creation of new ideas or elements to be composed in the finished work, these being invented in the composer's mind, commonly described as inspiration. This invention aids in this creation of elemental ideas falling into the first abovementioned category of melody and harmony. In this way, it does not compete with this prior art but complements it. In a linear view of the composition process, this invention assists in the creation of elements, prior to all elements being composed to form the complete musical work and comes before the use of existing computer aided composition tools. Because the invention deals with fundamental structural elements of music as distinct from composed musical pieces, the invention is described in terms of an apparatus and a method of musical invention rather than musical composition.

### DISCLOSURE OF INVENTION

In one aspect the invention resides in a computer assisted apparatus for musical invention including in combination, a computerised means adapted to enable input, computer modelling of and graphic display of structural elements, typically melody and harmony elements of a musical work or part of a musical work; means for the graphic display to be subsequently altered, and means for the musical work or part of a work whether in original or altered form to be sounded through the computer soundcard and speakers.

In another aspect, the invention resides in a method of musical invention utilising the apparatus as herein described including the steps of:

1. entering a musical piece by

(a) playing in real time on an electronic keyboard or similar device, or

(b) step programming of an electronic keyboard, or

(c) drawing the graphic with experimental musical elements using a computer keyboard and/or mouse device,

(d) entering musical notation through digital transfer or other means,

2. playing back the musical piece through the computer sound card and speakers to decide if further experimentation is required,

3. making experimental alterations to the graphic from musical elements stored on the reference database, from an operators library of previous works or from previously published works of others via the computer keyboard and/or mouse, or making alterations directly using the computer keyboard and mouse by an experienced operator familiar with the system,

4. repeating steps 2 and 3 until a final version of the musical piece is obtained,

5. playing and/or singing the final version of the experimental musical piece with a personal style based on ideas acquired during the experimental steps,

6. including the musical piece in a current or future composition, and

7. storing the final version of the musical piece in the reference library or database of the computer.

In order that the present invention be more readily understood and put into practical effect, the theory underlying the invention is now given:

Introduction

The following chapters set about to provide a view of music to be used as the basis for a computer program that would assist in the invention of musical ideas. Such a program would allow song structure and the relationship between melody and harmony to be viewed and manipulated. Experimentation in this format would assist in introducing more invention in chord sequences and melodic movements, while referencing the melody to harmony in respect of consonance and dissonance. While we hear a principal note in a melody, the voice or instrument may be sliding, bending, moving to it, away from it, around it, sounding before or after the beat, varying strength, thereby through consonance and dissonance, creating sensual experiences. If these sonic variations are understood, then they can be reproduced, and invention of new melody/harmony musical ideas may be assisted. In this way, new ideas may be assimilated into a composer's personal vocabulary.

There are 12 musical notes. We might consider on what basis these are determined, since it is obvious there are an infinite number to choose from given that a vibrating string can be divided in any number of places along its length. I would like to quote from “The Guitar Handbook” by Ralph Denyer:

“Harmonics are an important part of every note. Each time a guitar string is struck it vibrates in a complex pattern, and the sound it generates is composed of several elements. The basic building block of the sound is the ‘fundamental’. This is the loudest element we hear, and the one by which we identify the pitch of the note. It is the sound generated by the string vibrating in a single loop along its entire length. At the same time, the string produces a series of harmonics, overtones or upper partials. These are simply tones with frequencies that are multiples of the frequency of the fundamental, and they are generated by the string also vibrating simultaneously in shorter loops. They begin one octave above the fundamental and then rise in pitch in specific intervals—the fifth, the next octave, the following third, and so on.”

So the basis of music, the 12 semitone step pitches as found on the ‘circle of fifths’, is an arrangement of consonant tones whereby the next step satisfies consonance with the strongest new tone generated by the previous step. ‘C’ generates a strong overtone of ‘G’, ‘G’ generates a strong overtone of ‘D’ and so on. This consonance will also be seen to be the basis of musical scales or modes.

So, if we say that we call ‘C’ home, we can be gently lead away from home by consonance with the harmonics of the note last sounded. Going in a clockwise direction, after 12 tones we have come full circle and are home again at ° C.

The circle of fifths: C G D A E B F# Db Ab Eb Bb F C.

For our music to provide the sense pleasure of resolution, we must first establish home or key centre, a reference point for the listener and then sound dissonance. The pleasure of consonance is created by prior mild dissonance, in the same way that to enjoy the sense pleasure of a warm fire, one must first feel cold.

Let us say that going ‘up by fifths’ is consonant because we are given the tone of our new centre at each new step. We are gently prepared for change.

When we turn around and go anti-clockwise, ‘up by fourths’, consonance has not been prepared. The new tone sounds dissonance, since the tone we were previously hearing is now a harmonic overtone, albeit a strong one, making for mild dissonance.

A preparation to go up a fourth is very often achieved by a seventh chord, but in understanding how a seventh chord makes that preparation, we may see how it can be achieved in other ways and how that method may be employed to introduce chords from other places on the circle of fifths.

Chapter 1: Major Chords

The key of C major: C D E F G A B C, and the tonic major triad: C E G.

Every musical instrument or vocal sounds a series of harmonic overtones as well as the fundamental note. These run: octave, perfect fifth, major third. Excluding the octave then, the note most consonant with the fundamental is a note up an interval of a perfect fifth, and the next most consonant is up a major third. In the tonic triad, the C and G notes are strongly linked and are consonant. G is a perfect fifth above C. The E note, the next different harmonic overtone of C, is also linked, but not as strongly.

The triad C E G may be destabilised by adding the flat seventh to form the C7 chord. The strongest overtone of the Bb above the octave is the perfect fifth F, so the addition of the Bb suggests the F as a slightly dissonant tone in the ascendency, the same way that up by fifths movement suggests a rising tone and gives satisfying resolution. Once a mildly dissonant tone has been heard in the ascendancy, we find the best resolution if it completes that ascendency, so the change to the F is now expected and the F can be accorded dominance by making it the root of the next chord. In the case when the answer is confirmed in the harmony by sounding the F major triad F A C, it is called the perfect cadence. However, C could be reconfirmed as the answer to this musical question, or neither resolution offered, and the tension continued.

In looking again at the triad C E G, if the E were to rise up a semitone, we would still hear a note diatonic to C major, the F. This tone is called the suspended fourth. The F has a reasonable consonance, as its strongest overtone above the octave is a perfect fifth, C. It has however undermined the dominance of the C tone by replacing the E that confirmed the C, and by suggesting the rise of a new tone. It has created a mild dissonance and there is some suspense until an outcome is heard, in the same way that the seventh chord created uncertainty.

This proximity of diatonic notes, and the way either is heard as consonant with the root note C, provides a special place where the E/F may be worked by sounding the E and then pulling strongly or bending with a wide vibrato toward the F. If this melodic movement is played or sung over the chord C E G, it produces a musical uncertainty, or mild dissonance, which is pleasing to hear resolved. The strength and nature of any such resolution will determine how much tension there is in the music at that time.

This melodic movement between these two diatonic notes a semitone apart will be referred to as the first bend. If the symbol is used to indicate a melodic movement, singing or instrumental, with a wide vibrato bending above the note written immediately before it, then the previous idea with reference to the triad C E G may be shown as E˜F.

For this purpose, bends are defined as alternate raising and releasing of pitch in the idea of a wide vibrato that has the effect of maintaining interest since resolution of the contrasting tones is withheld. These bends are most often a semitone or less, and when less than a semitone they are referred to as microtonal and parameters include the speed and depth of bends. While with vocals or on some instruments notes are easily moved up in a linear way through bending, that is, without the vibrato effect of immediate release, for this purpose these are better distinguished as slides.

The bending of notes sharp with a wide vibrato is an essential sound of popular songs and music. While the first bend described above is mild, other available bends will produce differing suspensions. A suspension may be loosely defined as dissonance on a downbeat. Suspensions such as a non-chord tone sounded or suggested on an upbeat would be classed as a passing tone, lacking the emphasis to cause strong disruption.

With the triad harmony below it as a reference point, melody has many options to sound dissonance. To sound in agreement with the dominant bass tone is to come to rest and there is no tension to be resolved. C sounded over C E G. From there, the mildest dissonance is to sound the fifth of the triad, G, and from there, the third, E.

Of the diatonic non-chord tones, the fourth, F, is a reasonably consonant tone. The major sixth, A, is also soft consonance, sounding a strong overtone of the major third, E, in its harmonic series, while the second, D, is mild dissonance. The remaining diatonic non-chord tone, the major seventh, B, is sharp dissonance. A semitone step between any two tones is always sharp dissonance, due to their ratios. It is usually only heard as a passing note on upbeats filling in scale runs. However, it does have a particular prominence in the later discussion of bends.

Of the non-diatonic tones, the flat seventh, Bb, is mildly dissonant to the dominant tone at one tone distant and has therefore a similar strength of disagreement as the second tone, D. The flat third, Eb, is more consonant although slightly less so than the major third, E. The flat sixth, Ab, and the flat fifth, Gb, sit between the flat third and the flat seventh as regards dissonance. The Db is strongly dissonant to the tonic of the triad at one semitone away.

Short of fully sounding suspensions as described above, they may be suggested with bends to give milder uncertainties. A wide vibrato makes the interest by switching the dissonance on and off.

Bends may be named and examined by moving anticlockwise on the circle of fifths starting at the third of the triad. The first bend, E˜F, has a consonant starting tone and a consonant tone in the F; it is sweet and can be sounded as a wide bend in all genres. The second bend, A˜Bb, moves from the softly consonant major sixth, while the Bb sounds mild dissonance, a bluesy tone. It sounds well in Light Rock, Light Blues, and stronger Country music. The third bend, D˜Eb, sounds a mildly dissonant starting tone of D, and the Eb is light dissonance. A Light Rock sound if strongly bent, it is also common in Country Blues. The fourth bend, G˜Ab, has a consonant starting tone, being a chord tone; the Ab is only a slightly more dissonant tone than the Eb. It gives a mild Rock-Blues flavour. The fifth bend, C˜Db, starts at rest and bends toward a sharply dissonant tone in Db; it is moving to detract directly from the dominance of the C. It is heard in stronger Rock and Blues music, although it is probably not sounded with great depth. The sixth bend, F˜Gb, is mildly dissenting to the C tone both in the F and in the Gb, and is a slightly softer bend than the third bend. It is a common bend in the pentatonic Blues scale. The seventh bend, B˜C, is a different case in that the starting tone, B, is a scale tone, but it is strongly dissonant to the dominant tone, C, in the harmony. Therefore, this bend, when strongly sounded, moves to mild dissonance. As will be seen in the later analyses of songs, this function provides a special ability to allow melodic motifs to be repeated while adding the interest of a changing harmony below them.

As described above, a strongly dissonant tone such as the seventh tone of the C major scale may be bent toward the C to soften dissonance. This applies equally to non-diatonic tones, usually referred to as flatted notes. In genres such as Hard Rock or Strong Blues where flatted tones such as minor pentatonic scales are sounded over major harmony, the dissonance of these tones may be moderated in the same way. A common microtonal bend in Blues is a ¼ tone bend, bending off the flat third to ease dissonance. An example would be Eb˜E over C E G. Similarly, Ab˜A would sound as well, while Bb˜B is not as consonant since the major seventh is a dissonant tone. Other bends off non-diatonic tones can be considered in similar context.

Chapter 2: Key Centre

A scale is a selection of notes from the Circle of Fifths. Starting scales on different notes of a major scale gives differing step patterns. These become the relative modes. The name is derived from the Greek word for moods, since as the step patterns change, different flavours are heard through increasing dissonance.

Relative modes may be converted to parallel modes by starting each mode on the same note while maintaining the differing step patterns found in the relative modes. As more tones contradictory to the dominant bass tone are accumulated, the darker the overall scale becomes, hence the notion of moods.

Of these modes, the Ionian mode or Major scale is the most common musical scale in use since it forms a key centre with all major harmony. It is a consonant scale and provides a starting reference for dissonance.

For any tone selected to be a key centre, the tones either side on the Circle of Fifths are the most consonant, being a perfect fourth and a perfect fifth away. In the case of the C major scale, these are the fourth, F, and the fifth, G. This relationship forms the key centre referred to as the major seven-tone scale, and music starts with the construction of this scale.

The C major scale starts with the relationship of the F and G tones to C, and is then expanded by the way major triads sound consonance, a single tone, within themselves. This map of consonance is expressed as the scale that is found in the spelling of these three chords forming the major seven-tone scale.

This major scale, or Ionian mode, can prepare the change from the G major triad up a fourth to the C major triad, since a G7 chord can be created using a diatonic note F, and this will, as seen earlier, suggest the C. As well, when the F major triad is sounded, C is heard in the overtones and when there is a step up a fifth to C, called the Plagal Cadence, there has been a preparation and a resolution. A similar case exists with the C to G. With the step to the IV chord being unprepared, the Ionian mode has a slight inherent dissonance, although the change is mild being a perfect fourth, and does not require special preparation. The chord group of a key centre can be expanded to six chords by bringing in the relative minors of these three major chords to substitute for them. The relative minors have a general consonance since their spelling is within the scale, and they will sound well in any order as the three primary triads do.

However, whether or not to introduce the relative minor chords into a major progression will depend on audience tastes, since these chords have an inherent dissonance.

Prepared changes are neither desirable nor undesirable, but tend to be a parameter of musical genres. Darker tones are created by larger and more sudden contrasts. Some genres will have more taste for aggressive changes, fast and unprepared, and for the non-diatonic tones that undermine the dominant bass tones. Other genres will have less taste for strong change.

Chapter 3: Minor Chords

C major triad: C E G and C minor triad: C Eb G. As mentioned earlier, when the tones C E G are combined into a triad they are in harmony, in agreement with the C tone. When the E is flattened a semitone, there is a mild contradiction to the dominance of the C. All minor triads have this inherent instabilty. As its name suggests, the minor tone lessens the dominance of a bass reference tone.

The Ionian mode, or major scale, and the Aeolian mode, or minor scale, are the commonly used scales in popular songs and music since only these can provide a uniform tonality as well as a sense of key centre. The Ionian mode or major scale forms harmony of all major chords as the I, IV and V chords, while the Aeolian mode forms harmony of all minor chords as the I, IV and V chords. All other modes have mixed major/minor/diminished chords as the 1, IV and V. The uniform tonality, major or minor, of triads built on the three tones is also a reference against which contrasts are sounded. The Aeolian mode, or minor scale, is the only mode other than Ionian that satisfies this criterion. The minor scale is the scale formed by the spelling of the three minor triads of the key centre.

The minor mode does not offer the opportunities for the stronger cadences that the major scale provides. The plagal cadence, Fm-Cm, is weaker since the dominance of the bass notes F and C is lessened by their flatted thirds. An improvised perfect cadence is available by substituting the dominant seventh chord for the dominant minor chord. In the key of C minor, G7 substitutes for G minor, and this gives rise to the harmonic minor scale.

Referring to suspensions over minor chords, as noted above, once a softly dissonant tone has been heard in the ascendency, the best resolution sounds if it completes that ascendency and becomes the dominant tone. In a minor triad, there is a slightly dissonant tone sounded already in the harmony. Melodic tones that are consonant with that tone will be the musically sweetest. Since the tone in the ascension becomes supported in the minor context means that to our ear the scale starts on Eb. This step pattern is recognised as the relative major of C minor, Eb major, and therefore as a major scale and the same now applies for suspensions as for major chords. For ease of reference, it is reasonable to use the relative minor of C major, A minor, for these purposes of viewing suspensions. For C E G or A C E, the first bend is E˜F and the second bend is A˜Bb. The bend between two diatonic tones other than the first bend, the bend that is sounded toward consonance, is the B˜C. The other bends and suspensions are similarly comparable and the melody is at rest on C even in the minor harmony.

With the wide use of the major scale, suspensions are more easily recognised in relation to major triads. For the purposes of easier reference then, it is reasonable to relate suspensions over minor harmony to equivalent major suspensions. If the equals sign is used to note suspensions over minor harmony, then the B melody note over A C E is not a suspended second, but an=suspended seventh. As such, it is recognised as strongly dissonant to the C that is supported in this triad. Similarly, D is an=suspended second, and so on. As will be seen in the analysis of songs, this commonality of suspension provides the ability to repeat melodic motifs or ideas while employing contrasting harmony with different major/minor related chords.

Chapter 4: Diatonic Chords of C Major

The B diminished chord, B D F, is not considered here since it is not commonly used in popular songs and music. Looking at the other diatonic chords, namely the three primary chords and their relative minors, C/Am, F/Dm, G/Em, it was previously mentioned that the relative minors could be seen as possible substitutes for the relative majors, being built on the same scale but having inherent dissonance.

Chord changes in a song add interest, contrast and strength to downbeats, but balanced against this is the inherent dissonance of minor chords and whether that suits all tastes. Three major triads define a scale and are complete harmony for any melody constructed on the scale. However, as mentioned above, the commonality of scales and suspensions in relative major/minor chords does promote opportunities for repeating melodic ideas or motifs, but with the variation and interest of changing harmony.

In the C major and the A minor triads, the melodic suspensions, whether sounded as full suspensions or as bends, are the same and they function in the same way. They reference to the same dominant bass tone or tone in the ascension, regardless of whether the music or song is in the minor key or major key, since that distinction is heard only in the way the music opens, resolves as it moves, and closes.

Chapter 5: Seventh Chords

Seventh chords, like minor chords, have an inherent dissonance. There is a mild overtone of the flat seventh suggesting change. The melody sounds consonance when it adds weight to that change.

The melody played or sung over a seventh chord can add the stimulus of the first bend and be in agreement with the tone suggested by the flat seventh. This is to say, both harmony and melody push for resolution to the tone in the ascension. Since the harmony is already stimulating the B˜C uncertainty, then the first bend B˜C in the melody will sound consonance and a greater depth of bend is available. The same applies with the second bend, E˜F. These bends are consonant with the sound of change. This effect is also noticeable with A˜Bb, D˜Eb and G˜Ab, the second, third and fourth bends; they are much sweeter than usual, and depth of bend can be increased here as well.

If dissonance is a tension that may be resolved, similarly tension can be created and maintained by interrupted cadences that leave a seventh chord either unresolved or less forcefully resolved.

Interrupted cadences in C major are as follows:G7-A, G7-F, G7-Em, G7-D7. The first two of these cadences sound the C in their chord tones but not as the root, so satisfactory resolution is not given. Such a progression maintains interest.

The other two interrupted cadences can also maintain uncertainty. The Em sounds well as it is the relative minor of G major, and as mentioned earlier, melodic motifs or other ideas built on particular bends can be continued with the variation of different harmony. The D7 will point back towards the G7 and could be used to hold continuing interest in C by melodic bending of the bluesy second bend, B˜C.

Seventh chords are commonly used in Blues to add tension to a major progression. Their dissonant tonality also assists in the introduction of flatted melodic notes and other suspensions. This means that bends are sweeter than usual over seventh chords, since, as mentioned earlier, there is a consonance in their disagreement with the bass tone. They can be pushed a little further which is pleasing since bends are a prime flavour in Blues-Rock music, although these substitutions are also heard in Country music and all popular music.

Chapter 6: Scales

The melodies for popular songs and music are commonly composed using five, six and seven tone scales and these are the major and minor scales or parts of the major and minor scales.

The major six-tone scale produces a brighter sound than the seven-tone, since it drops the most dissonant tone from the seven-tone scale, the seventh.

The five-tone major pentatonic scale (1 2 3 5 6) is widely used in Country music and major Blues. The five tone minor pentatonic scale (1 b3 4 5 b7) is commonly used in Blues-Rock music.

By using these different scales at different times, for example in a verse, chorus or bridge, over different harmony such as major, minor or seventh chord, contrasting moods are provided.

It is also true that there is no restriction on any tone in any melody, although taste is founded in the conventions to which we are accustomed. Some select inclusion of flatted tones in major scale melodies can produce interesting variations.

Chapter 7: Non-Diatonic Chords in C Major

The following are common non-diatonic chords heard in the context of the C major scale. C minor, D major, E major, F minor, G minor, A major, B minor, Bb major, Eb major, Ab major. Chords with any non-diatonic note would not be likely to appear in the milder genres. Chords with one non-diatonic note would appear in Light Rock and Country rock, and chords with two non-diatonic notes are commonly heard in Hard Rock.

While melody remains a particular diatonic scale, harmony containing non-diatonic notes will cause dissonance, which can be used effectively for contrasting phrases or parts of phrases, or contrasting sections. If the melody moves from the original diatonic scale and shifts to follow the harmony to sound the scales suggested by that harmony, then a key change has occurred and dissonance will not necessarily increase.

These chords will all sound more or less dissonant in respect of a C major scale melody. For example, G minor sounds the mild dissonance of the flat seventh, Bb, while A major sounds the sharp dissonance of the flat second, Db. The dissonance of the other non-diatonic chords and of their relevant seventh chords C7, D7, E7, F7 and A7, can be similarly inferred.

Preparation of non-diatonic chords may be effected in the previous melody by sounding or suggesting the non-scale tones or tones a perfect fifth below them. Their introduction can also be aided by bending the nondiatonic tone on the chord change. Looking at the E major, A major and D major, and the E7, A7 and D7, if the first bend is sounded in the melody, these chords are more consonant, as a note diatonic to C major is suggested. Dissonance is largely reduced if the first bend is sounded in the melody on the downbeat with the new non-diatonic major chord. A wide first bend is pleasing by itself, but in this way, it can also help to introduce the non-diatonic chord. Sounding of second bends in these three chords will also be more musical and could be used to soften the impact of the chord's dissonance. An advantage of major chords used as substitutes for diatonic minor chords is that they sound their own inherent consonance.

In a similar way to the non-diatonic major chords, bending the flat third toward the major third lessens the dissonant impact of the three non-diatonic minor chords: G minor, C minor and F minor. In other words, treat it as a first bend for softening the minor flavour within the chord itself, as well as the chords dissonance with regard to key centre.

Again, this will generally be effective if the melody sounds these bends on the downbeat with the chord change. However, these things are a matter of taste, and the chord's dissonant tonality may be emphasised if the melody sounds other tones usual to any minor chord. This will reinforce its minor quality and sound stronger change.

The D minor chord may assist introduction of the Bb major chord, since Bb major shares two notes in common with D minor. This circumstance has implications for further movement on the Circle of Fifths. As mentioned in the Introduction, travelling clockwise on the Circle of Fifths is consonant, prepared, and many compositions use this to travel to new key centres. Having two notes in common from the minor to the major a fourth above it provides consonance to travel anti-clockwise on the Circle of Fifths as an alternative to using seventh chords.

In the key centre of C, there are six chords most usually associated with the Hard Rock genre. These are the I, IV and V (C, F and G) and the flat third, flat sixth and flat seventh (Eb, Ab and Bb), all played as major chords.

From earlier chapters it was seen that relative major and relative minor are built from the same scale, and consonance and dissonance function on the same tones. In this way, Eb, Ab and Bb represent the key centre of C minor. The combined scale of these six chords becomes a combination of the major and minor scales.

For the stronger dissonance of the genre, any melody may sound tones from C minor scales over C major diatonic harmony, or C major scale tones over Eb, Ab and Bb. Alternatively, for contrasting consonant sections, C major scales may be sounded over diatonic major harmony, or C minor scales may be sounded over Eb Ab and Bb. As well, for further harmony choices, relative minor chords may be substituted for any chords in this group. Any major chord that moves up a minor third, three semitones, to another major chord, always provides a gateway between these two centres and sounds reasonably well, since it is always the major tonality moving to the equal minor tonality.

Chapter 8: Slides and Accents

Accents add emphasis to the sound of songs and music. Anthems provide a clear example of accents where nearly every syllable is on a downbeat, that is, pronounced with strength. The more common meters are iambic, one accented syllable followed by one unaccented syllable, or dactylic, one accented syllable followed by two unaccented syllables.

It is more passionate to have more accents and stronger accents. This effect is increased further where dissonant notes are accented, such as a non-chord tone or even a non-diatonic note on a downbeat rather than on an upbeat.

In most cases, the accented syllables are consonant-vowel sounds. This allows an explosive sound from the consonant that is not available with a vowel. If these syllables on strong beats are open vowel sounds, then to accent them requires special effort, and in making that effort, even more strength is sounded. It is also the case that to accent any syllable that is not usually accented creates a passionate emphasis.

Passionate expression is commonly found in songs in the fracturing of words that results in a vowel sound being held and then accented one or more times on downbeats. For song writing, this fracturing is the accenting of vowels as opposed to holding a vowel over one or more beats or parts of a beat, which is the same suspension, but less strongly expressed. Rising pitch while holding or fracturing a vowel adds more suspense before the tone finds eventual resolution. Held or fractured syllables are necessarily vowels.

It is not always the case that the match of syllables changing with meter is lost to accommodate held vowels. In many cases, the vowels are stretched onto part of the next beat and then the syllables that fulfil the meter are sounded more quickly.

All passionate songs have these devices in varying quantity, and songs of any genre may be examined to appreciate their use. A summary of increasing passion would be as follows:

(a) holding vowels over and then catching up the other changing syllables with meter

(b) giving vowel sounds their own additional beats or parts of a beat

(c) fracturing—further than giving vowels additional beats, noticeable accents are sounded on the strongest downbeats, or even on all downbeats

(d) fracturing with pitch changes

(e) fracturing with pitch changes and chord changes

The bends such as the first and second that are usually sounded with greater depth would be seen as most musical and effective for the purpose of holding and fracturing syllables.

Ascending slides signal sadness or submission, bringing an empathetic response. They are used to effect in genres that propose quiet themes. Descending slides indicate a more competitive tone. Slides occur on accented beats as they build to the accent, starting on the +, the top of the upbeat, and building to the accent on the bottom of the downbeat.

Slides will be most consonant when starting on a chord tone and moving to another chord tone. It is usual in moderate genres to slide from a chord tone to give consonance before sounding a non-chord tone or suspension. Typical slides sounded over C E G then would be:

(i) C-D with blues bending above this would be C-D˜Eb.

(ii) E-F or C-E˜F

(iii) G-A with usual bluesy bending above this would be G-A˜Bb.

These slides become bends when the tone moves away from and back to a melody note to give a momentary dissonance that is quickly resolved.

Chapter 9: Song Writing

Songs and music are analogous to speech. Our speaking voices and the pitch we use to express ourselves to others is musical. When we are passionate, we talk more quickly and in a higher overall pitch. When we are more peaceful, our voices drop into our chests and we talk more slowly. In a song then, pitch, as well as the speed of changes of pitch and the overall tempo of the music will be in balance with the words of the lyrics. It is usual to be passionate, but passion ebbs and flows, rises and falls, and contrasts are found in all songs and music. These contrasts give effect to each other.

Common contrasts are consonance/dissonance, structural contrasts such as quieter verses/passionate choruses, melodic contrasts within phrases, tempo changes and loudness. Included in the balance of these aspects is the number of beats and parts of a beat that have a melody note or a syllable. A faster tempo with vacant beats may not sound as busy, passionate, as a slower tempo with full iambic meter. Pauses, stretched vowels, fractured vowels, pitch movements, accents, speed, comparative loudness, singing before, on or after the beat—these things convey the underlying emotion. The dictionary meaning of what is said is not as important as the way it is said and the amount and arrangement of consonance and dissonance, the strength of accents and suspensions and so on are the stimulus, and music without lyrics is equally emotionally expressive as songs.

With melody, wide melodic movement sounds happiness or a bright feel, while flat melodic lines indicate an emphatic tone. With lyrics, rhyme and alliteration are consonance. As with the accompaniment, contrast gives them interest. In performance, harmony and reverberation are consonance. Vibrato is continually creating and resolving dissonance for the pleasing effect of resolution.

If syllables or melody notes are sung or played right on the beat, this is heard as forthrightness. This would be the case for, say, an anthem. If sounded before the beat, aggression is interpreted. Heard after the beat, they indicate sadness or submission. These nuances could be referred to as performance effects that slightly modify song meters.

In the melodic meters shown for the songs analysed in Chapter 10, it will be seen that melody employs patterns. While the rhythm below the melody may be unchanging, one of the contrasts that provide listening interest is to construct different melodic meters. These can be formed by stretching a syllable on the same beat of every bar or by leaving a beat or part of a beat vacant and so on. The different meters, and the ‘by numbers’ nature of songs and music, can be appreciated by singing the meters to the melody.

Meter and pitch build different melodic motifs that repeat or vary in common ways. The graphical method employed in Part Two displays this, lending itself to musical comprehension and invention.

Dissonance may be limited at any one time, but changing the dissonant part of a musical work forms contrasts. An example is to have consonant melody over harmony that is more dissonant or vice versa. Harmony selection for any diatonic melody creates the tone that is a genre. Another example would be to have consonant tone with high pitch, such as falsetto singing.

Chapter 10: Song Analysis

The two graphic representations employed here show melodic movement against the changing harmony, displaying the dynamics of the music. They show the phrase, sentence, verse, chorus, bridge structures and how they peak and contrast with each other, along with repeating and changing melodic motifs, instrumental fills and other musical suspensions. In addition, different bends are described, as well as chord and non-chord tones. This has the effect of taking the music out of the inspirational realm, making it cognitive and tangible.

For consistent reference, the songs are all shown in the key of C/Am since the principal function of differing keys in popular songs and music is to suit the range of vocalists and certain instruments.

Generally, only the strongest bends are shown; however, with most of the songs shown here there are always the smaller bends, Blues bends, heard particularly in the Light Rock and Hard Rock genres. Along with the smaller slides, these are probably best referred to as general performance effects. The meter is also rounded off without the associated minor performance effects described in Chapter 9.

Legend for drawings: Chord Tone-x inside circle; Non-Chord Tone-x; Slide-slanted lines; Strong Vibrato-crossed arrow.

Drawing no. 2/3 ‘Nowhere Man’

The melody is diatonic major scale. In the verse, the melodic motif repeats at different pitch over changing harmony for contrast. The opening of the verse at the highest pitch has the effect of a more passionate opening.

A dissonant peak in the third phrase comes with major sixth suspensions over F A C, and with the F minor chord sounding Ab. On the downbeat of the chord change to the F minor, the melody note of E is pulled towards F to ease dissonance while maintaining the motif. Before the third phrase, the only non-chord tones are on upbeats.

There is a major sixth/second bend suspension on the first downbeat of the last bar. This partially resolves to the fifth, C, of the F major harmony, but resolution to the tonic of the harmony is not completed until the change to C major.

Verse meter: 1+2− 1+2− 1+2+ 1+2−

1+2+ 1+2+ 1+2−

In the chorus, the substitution of the Em for G sounds dissonance, a stronger flavour for Light Rock. A higher pitch opening in a chorus is usual. In this song, the step up from the verse is a perfect fifth from C to G (as opposed to a more common octave step). In this case, the step to the fifth G above C E G allows the third phrase in the chorus to have a pitch peak that still keeps the whole song within a singing range of one octave. Another possible option is a step of an octave plus a major third. When the step is to the octave plus a major third, the first bend may be sounded. Alternatively, for the opportunity to sound the first bend and keep the range moderate, a step from the fifth of the melodic scale to the major third above it is effective.

The chorus repeats the melodic motif for the first and second phrases, peaking it higher in the third phrase for crisis. The third phrase also includes suspended seconds over F A C on strong downbeats. In the fourth phrase, the V7 chord tension sends the music back to the verse. The busier meter of triplets adds to the tension of the third and fourth phrases.

$$\begin{matrix}\text{Chorus meter:} 2 + 1 ⋯ + 1 + \\ 2 + 1 ⋯ 2 + 1 + \\ 2 + 1 ⋯ + 1 + a2 + 1 + a2 ⋯\end{matrix}$$

Drawing no. 3/3 ‘All My Loving’

The melody is diatonic major scale. The song has the easy-listening flavour of mostly smooth, rising and falling melody without sudden pitch changes and without a noticeable four-phrase structure with crisis or peak.

In the verse, the opening harmony moves easily from the flat seventh, Bb major, to the ii minor, Dm, as they have two notes in common. The perfect cadence confirms the melodic scale. Some strong vibrato is available in first, second and third bends on the held tones. Reiteration adds a momentary stronger flavour moderated by first and second bends, and travels across from the A minor to the F major, being a second bend in one and a first bend in the other.

The verse motif repeats twice. The first time it hangs up on the first bend D˜Eb over harmony of Bb major. The second time it falls to rest on the tonic of the C major harmony.

$$\begin{matrix}Verse meter \text{:} 2 + 1 ⋯2 + 1 + ⋯ + & 2 + 1 ⋯ 2 + 1 ⋯ 2 + \\ 1 ⋯ 2 + 1 + ⋯ + & 1 ⋯ 2 + 1 + ⋯ 2 + \\ 1 ⋯2 + 1 ⋯2 + 1 ⋯ & 1 ⋯ 2 + 1 + ⋯ + 1 ⋯\end{matrix}$$

In the chorus, the first phrase again holds tension to call up a repeat of the motif by way of the unresolved mild dissonance of the first bend. Two descending, similar motifs are a common feature of many choruses. The final plagal cadence, F-C, holds tension with the fifth C over the F major until full resolution is achieved with the tonic C over C E G.

In the verse and chorus, the substitution of minor chords and non-diatonic chords brings an edge to the song that would otherwise be too consonant for the genre.

$$\begin{matrix}Chorus meter \text{:} 2 + 1 + ⋯ & 1 + 2 + 1 ⋯ \\ 2 + 1 + ⋯ & 1 + 2 + 1 ⋯ \end{matrix}$$

### BRIEF DESCRIPTION OF THE DRAWINGS

In order that the present invention be more readily understood and put into practical effect, reference will now be made to the accompanying illustrations wherein:

Drawing 1/3 is a basic non-colour version of a preferred graphic representation which exemplifies a typical display of this invention. On a horizontal line at the bottom of the graphic is displayed the sequence of harmony chords. These are divided in relation to music bars and are further subdivided relative to beats per bar or time signature for the work. Musical sections such as verse, chorus are also delineated. This will be referred to as the chord sequence. On a vertical line at the left of the graphic is arranged in ascending order of pitch, bottom to top, the appropriate range of notes of the melodic key for the work divided into semi-tone steps. This will be referred to as the melodic scale.

Chord tones and non-chord tones are shown as crosses in circles and plain crosses, respectively, and specific bends indicated with an arrow-headed wavy line. Melodic notes are joined with straight lines in a way that assists in the visual conception of the different phrases, melodic motifs and parts, and also shows the length of sounding of the individual notes. Where these lines are slanted, a slide is indicated, with the distance travelled horizontally representing the time duration of the sounding of the slide, and the distance travelled vertically representing the melodic interval of the slide.

FIGS. 2/3 and 3/3 are diagrams accompanying the text of the theory underlying the invention.

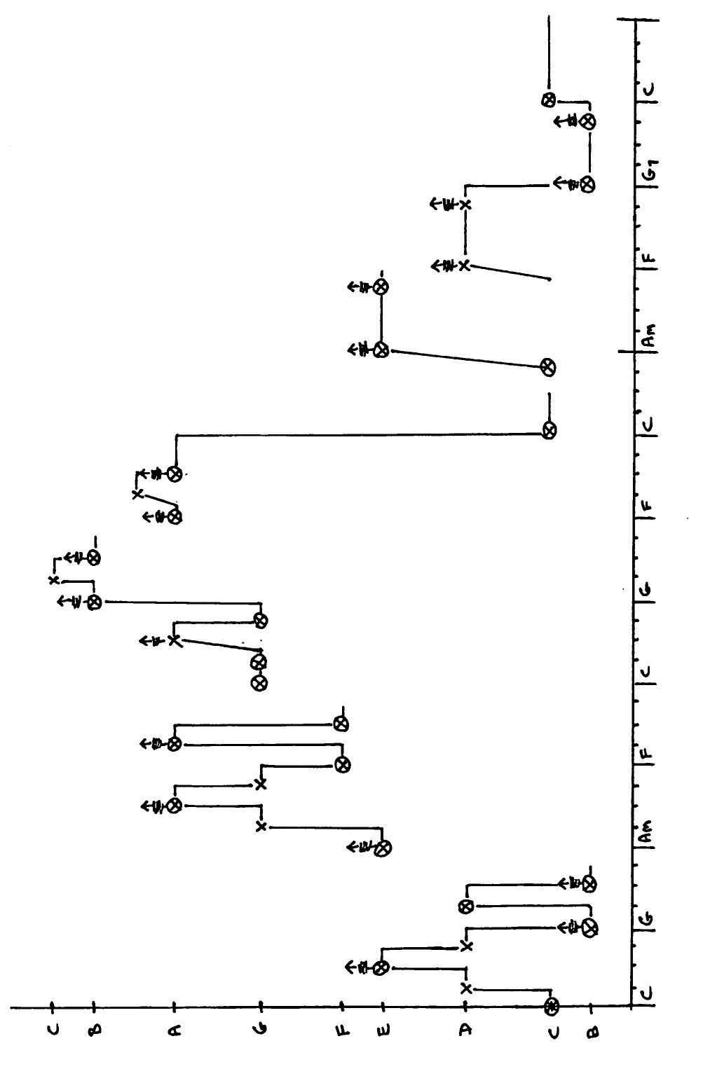

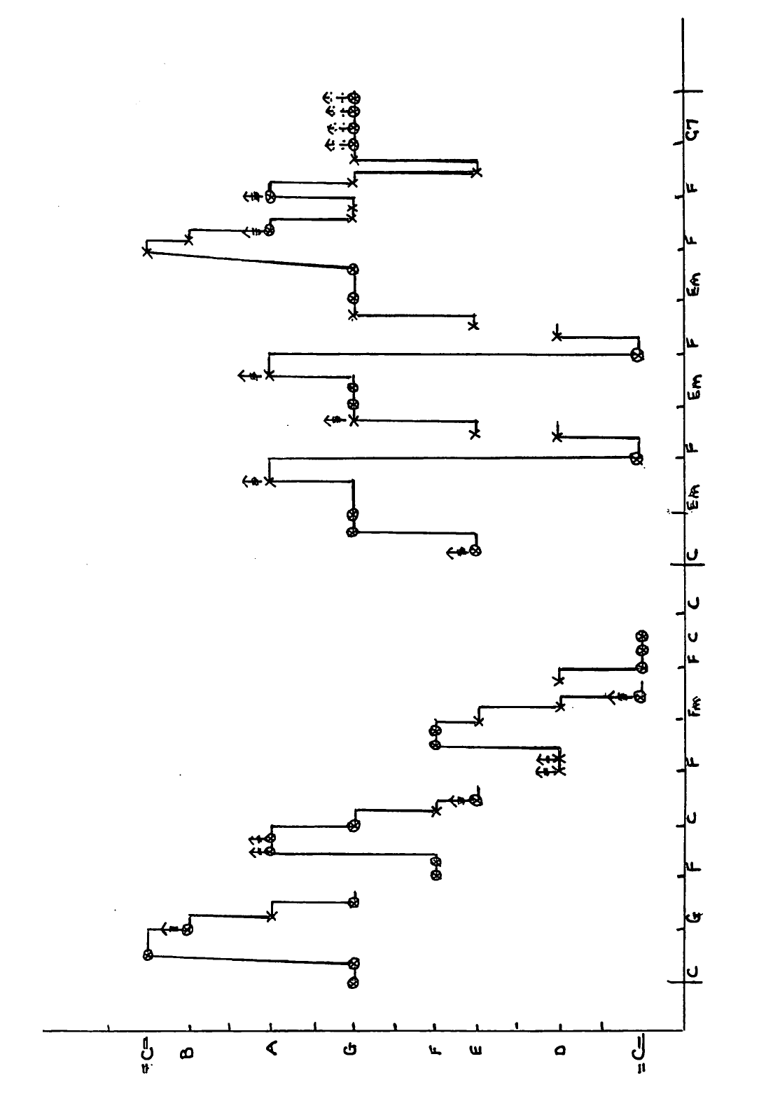

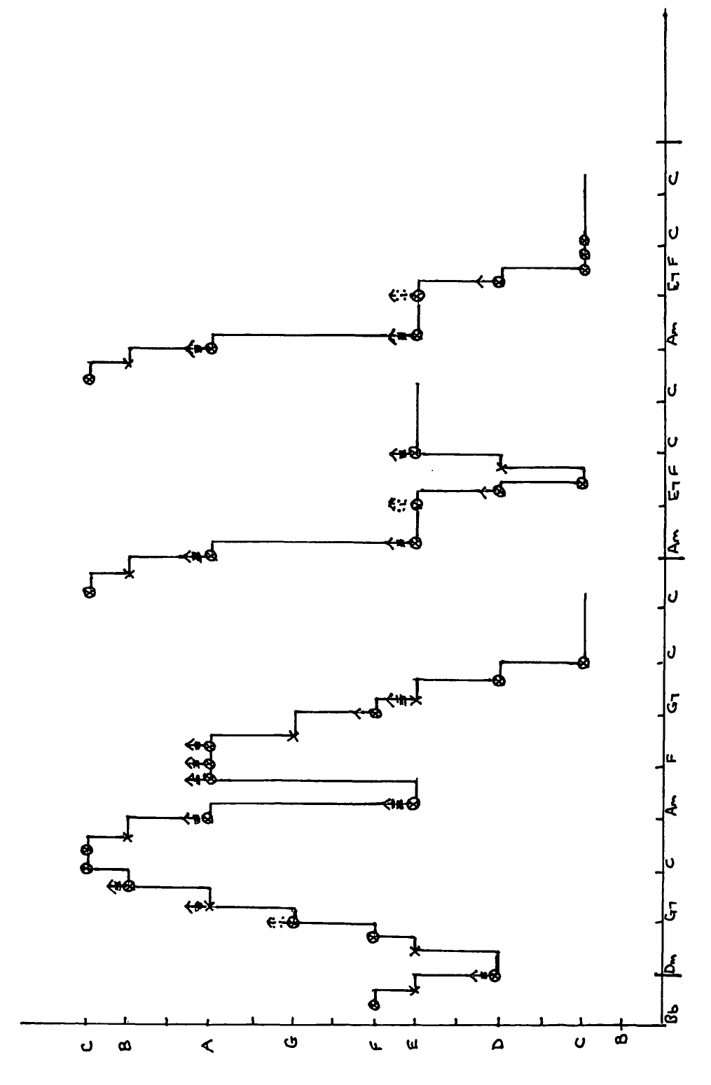

### BEST MODE FOR CARRYING OUT THE INVENTION

Preferably, the computerised means is adapted to enable input of musical parameters that would relate generally to certain styles of music or musical genres, for example, jazz, rock, classical, developed from music theory, inclusive of musical keys and chord sequences.

Preferably the computerised means incorporates audiovisual means adapted to enable audio playback and display of a graphical model of the musical work, wherein in operation, a piece of music can be played back and representation of key, time, chord sequences of harmony and melody elements can be displayed, and wherein an operator can alter any part of the musical work and/or parameters to vary the graphical model thereby facilitating the creative process.

Preferably the computerised means is a personal computer with a sound card and the visual display means is the computer visual display unit.

Preferably, musical information is entered into the computer by means of a keyboard, other suitable device or the computer keys and mouse.

Preferably the musical information is entered in digital format and can include audio files in a compression/decompression protocol.

Preferably the computer incorporates a reference database of music theory and music information, inclusive of consonant and dissonant parameters relevant to recognised genres for example, jazz, rock, classical and other music types.

Preferably the graphical model will display harmony chord sequences and related melodic movements, including phrase, meter, sentence, verse, chorus, bridge structures and provides a visual indication of how they develop, peak and contrast with one another.

Preferably the graphical model includes colour to represent one or more variables.

Additionally, in a colour representation, consonant and dissonant bends can be shown together with chord and non-chord tones and other musical devices.

Preferably the graphical model or parts thereof can be displayed as staff notation and vice versa.

### INDUSTRIAL APPLICABILITY

This invention would complement the current musical composition type software that has enjoyed a worldwide boom since the digital revolution in music recording and processing. It has the capacity to become a common component of this software, which is currently marketed as both stand-alone personal computer programs and as programs incorporated in electronic keyboards and other outboard devices.

It would also stand-alone and be a fit with the many personal computer software programs extensively marketed through the Internet and other electronic sales outlets.

What is claimed is:

1. A computer assisted apparatus for musical invention including in combination, a computerised means adapted to enable input, computer modelling of and graphic display of structural elements, typically melody and harmony elements of a musical work or part of a musical work; means for the graphic display to be subsequently altered, and means for the musical work whether in original or altered form to be sounded through the computer soundcard and speakers.

2. The musical invention apparatus of claim 1 wherein the computerised means is personal computer.

3. The musical invention apparatus of claim 1 wherein the computerised means is integrated with an electronic keyboard or other electronic musical device.

4. A method using a musical invention apparatus comprising the steps of
(a) entering a musical piece into a suitable electronic device either by
(i) playing in real time on an electronic keyboard or similar device, or
(ii) step programming of an electronic keyboard, or
(iii) drawing the graphic with experimental musical elements using a computer keyboard and/or mouse device, or
(iv) entering musical notation through digital transfer or other means.
(b) playing back the musical piece through the computer sound card and speakers to decide if further experimentation is required,
(c) making experimental alterations to the graphic from musical elements stored on the reference database, from an operator's library of previous works or from previously published works of others via the computer keyboard and/or mouse, or making alterations directly using the computer keyboard and mouse by an experienced operator familiar with the system,
(d) repeating steps (b) and (c) until a final version of the musical piece is obtained,
(e) playing and/or singing the final version of the experimental musical piece with a personal style based on ideas acquired during the experimental steps,
(f) including the musical piece in a current or future composition, and
(g) storing the final version of the musical piece in the reference library or database of the computer in musical notation and/or graphic form.
